(19) United States
(12) Patent Application Publication
(10) Pub. No.: US 2002/0151829 A1
(43) Pub. Date: Oct. 17, 2002

(54) COMBINATION MASSAGING PAD

(76) Inventor: Hsieh-Chang Tien, Tu Cheng City (TW)

Correspondence Address: VARNDELL & VARNDELL, PLLC, 106-A South Columbus Street, Alexandria, VA, 22314, US

(21) Appl. No.: 09/832,945

(22) Filed: Apr. 12, 2001

(51) Int. Cl. A61H 7/00

(52) U.S. Cl. 601/138; 601/136

(57) ABSTRACT

A combination massaging pad of do-it-yourself design formed of a plurality of unit pads connected to one another side by side, each unit pad having a plurality of top massaging studs, a plurality of peripheral coupling notches, a plurality of upright coupling rods and upright positioning rods disposed at the periphery to serve with the coupling notches for enabling the unit pads to be fastened to one another by fastening respective coupling notches to respective upright coupling rods and upright positioning rods, and a plurality of coupling devices provided at the coupling notches which when two unit pads are attached together, secure the respective upright positioning rods of the unit pad attached thereto.

### BACKGROUND AND SUMMARY OF THE INVENTION

The present invention relates to a massaging pad and, more particularly to a do-it-yourself design of combination massaging pad.

It is well known that massaging the acupuncture points of the sole of the foot is helpful to the health. A variety of massaging devices have been disclosed for this purpose, and have appeared on the market. However, it is inconvenient to use these massaging devices to massage the sole of the foot.

It is one object of the present invention to provide a combination massaging pad, which can be freely arranged on the floor of a kitchen, bathroom, living room, or the like, subject to the desired area, to massage the foot when walking thereon. It is another object of the present invention to provide a combination massaging pad, which is of do-it-yourself design. It is still another object of the present invention to provide a combination massaging pad, which has drainage means for carrying off water when used in a bathroom. It is still another object of the present invention to provide a combination massaging pad, which does not slip when positioned on the floor. According to one aspect of the present invention, the combination massaging pad is comprised of a plurality of unit pads connected to one another side by side. Each unit pad comprises a plurality of top massaging studs, a plurality of peripheral coupling notches, a plurality of upright coupling rods and upright positioning rods disposed at the periphery to serve with the coupling notches for enabling the unit pads to be fastened to one another by fastening respective coupling notches to respective upright coupling rods and upright positioning rods, and a plurality of coupling devices provided at the coupling notches which when two unit pads are attached together, secure the respective upright positioning rods of the unit pad attached thereto. According to another aspect of the present invention, each unit pad further comprises a patterned opening, and a patterned patch fitted into the patterned opening. According to still another aspect of the present invention, each unit pad further comprises a plurality of bottom studs adapted to support the combination massaging pad above a flat floor surface, so that a space is left between the bottom sidewall of each unit pad and the floor surface on which the combination massaging pad is supported for drainage of water. According to still another aspect of the present invention, each unit pad further comprises a plurality of mounting through holes for the mounting of vacuum mounts for positioning on a flat floor surface.

### BRIEF DESCRIPTION OF THF DRAWINGS

FIG. 1 is a plain view of a combination massaging pad constructed according to the present invention.

FIG. 2 illustrates the connection relation between two unit pads according to the present invention.

FIG. 3 is an exploded view of a unit pad according to the present invention.

FIG. 4 is a top assembly view of a part of a unit pad according to the present invention.

FIG. 5 is a sectional assembly view of a part of a unit pad according to the present invention.

FIG. 6 is a plain view of an alternate form of the combination massaging pad according to the present invention.

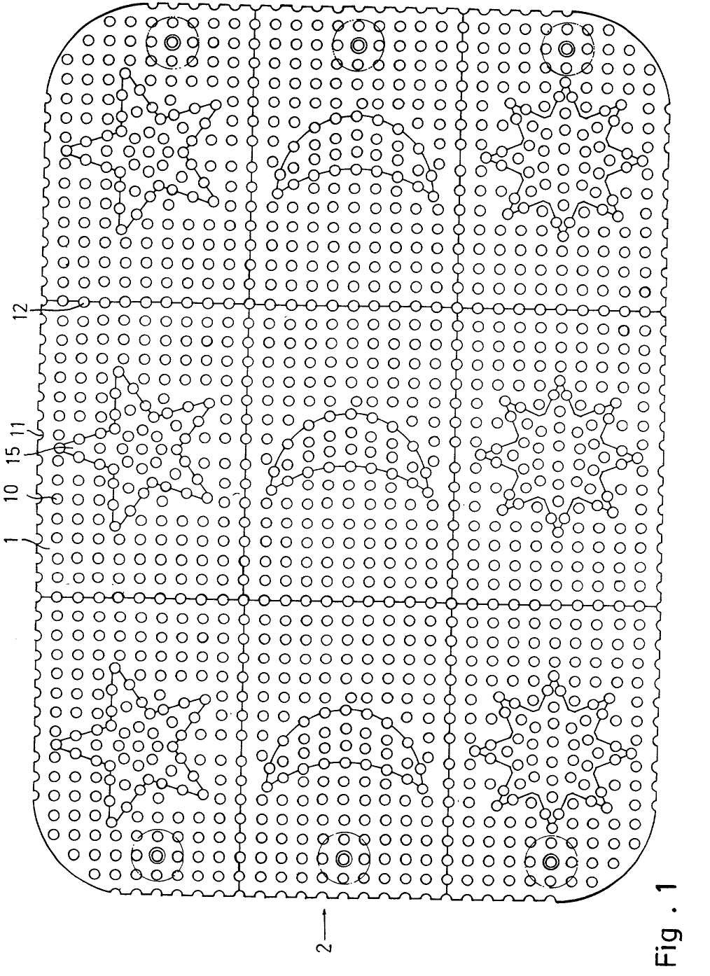

### DETAILED DESCRIPTION OF THE PREFERRED EMBODIMENT

Referring to Figures from 1 through 5, a combination massaging pad 2 is comprised of a plurality of unit pads 1 fastened together. Each unit pad 1 comprises a plurality of massaging studs 10 at the top sidewall thereof, a plurality of coupling notches 11 and vertical coupling rods 12 and vertical positioning rods 12′ disposed at the four peripheral sides thereof, and a plurality of coupling devices 13 respectively provided in some of the coupling notches 11. The coupling devices 13 each comprise a connecting strip 130 extended from the bottom edge of one coupling notch 11, and an upright plug rod 131. The upright plug rod 131 has a bottom end integral with the respective connecting strip 130, and a top end terminating in a round head 132. The positioning rods 12′ each have a bottom plughole 120 and an expanded retaining chamber 121 in the bottom plughole 120. The size of the expanded retaining chamber 121 fits the round head 132 of each upright plug rod 131. Each unit pad 1 further comprises a plurality of bottom studs 14 disposed at the bottom sidewall thereof and adapted to support the respective unit pad 1 above a flat floor surface, so that a space is provided between the bottom sidewall of the unit pad 1 and the floor surface on which the unit pad 1 is supported for drainage of water. The vertical coupling rods 12 and the vertical positioning rods 12′ have a respective top side disposed at the same elevation, however the bottom end of each of the vertical positioning rods 12′ is disposed above the elevation of the bottom end of each of the vertical coupling rods 12. The elevation difference between the bottom end of each of the vertical positioning rods 12′ and the bottom end of each of the vertical coupling rods 12 equal to the thickness of the connecting strip 130 of each coupling device 13. When fastening two unit pads 1 together, the vertical coupling rods 12 and vertical positioning rods 12′ at one peripheral side of a first unit pad 1 are respectively attached to the peripheral coupling notches 11 of a second unit pad 1, and then the respective upright plug rods 131 of the respective coupling devices 13 are respectively plugged into the respective bottom plugholes 120 of the respective vertical positioning rods 12′.

Referring to Figures from 3 through 5 again, each unit pad 1 further comprises a patterned opening 16, and a patterned patch 15 fitted into the patterned opening 16. The patterned patch 15 comprises a plurality of a plurality of massaging studs 150 at the top sidewall thereof, a plurality of vertical coupling rods 151 and vertical positioning rods 151′ disposed at the peripheral sides thereof. Each unit pad 1 further comprises a plurality of coupling notches 160 disposed around the patterned opening 16 and adapted to receive the vertical coupling rods 151 and vertical positioning rods 151′ of the patterned patch 15, and a plurality of coupling devices 161 respectively provided in some of the coupling notches 160 The coupling devices 161 each comprise an upright plug rod 162. The upright plug rod 162 has a top end terminating in a round head 163. The positioning rods 151′ each have a bottom plughole 152 and an expanded retaining chamber 153 in the bottom plughole 152. The size of the expanded retaining chamber 153 fits the round head 163 of each upright plug rod 162. The patterned patch 15 further comprises a plurality of bottom studs (not shown) disposed at the bottom sidewall thereof and functionally serves like the bottom studs 14 of the unit pad 1. The connection between the patterned patch 15 and the patterned opening 16 is similar to the connection between each two unit pads 1.

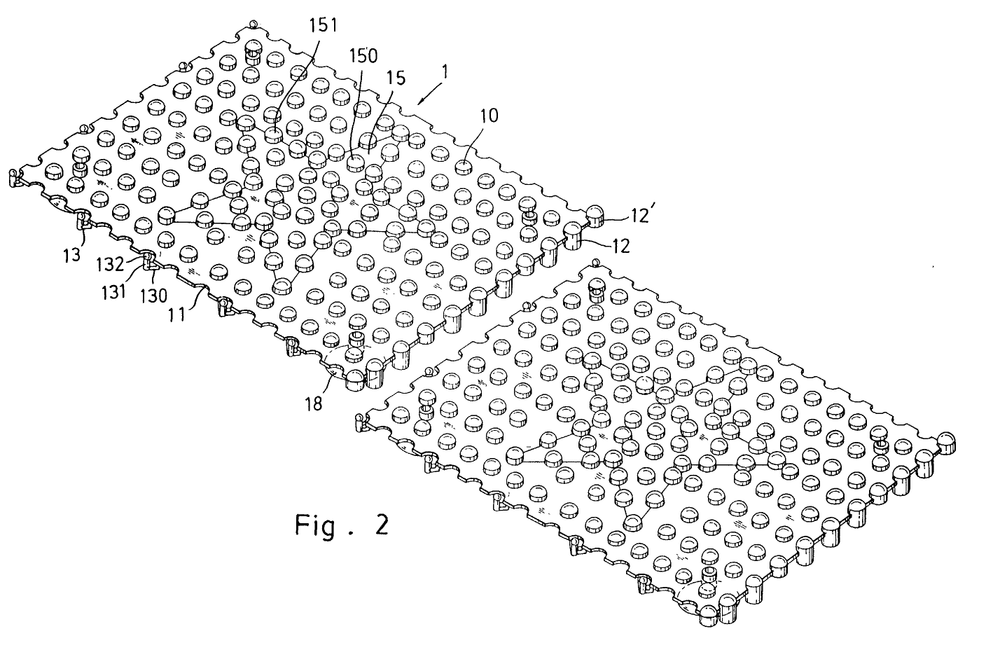

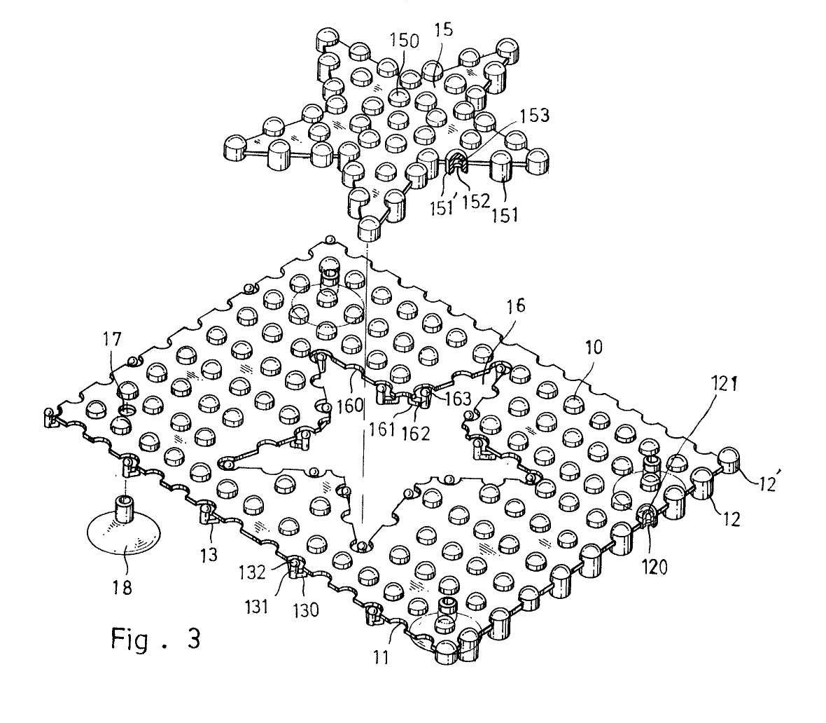

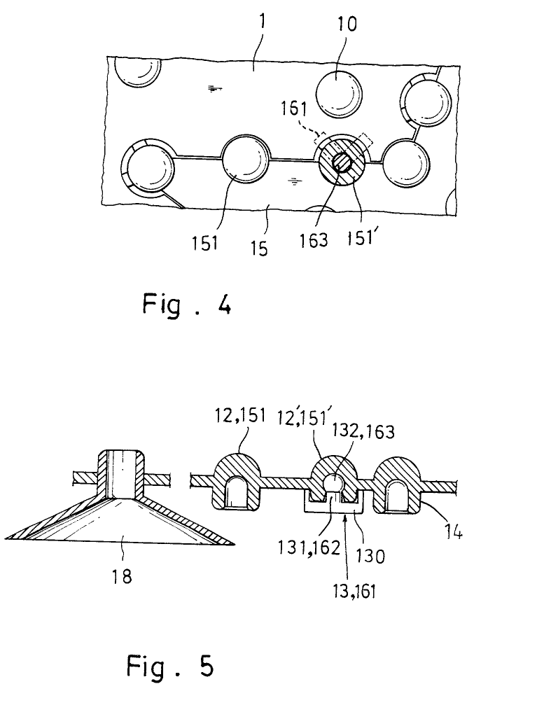

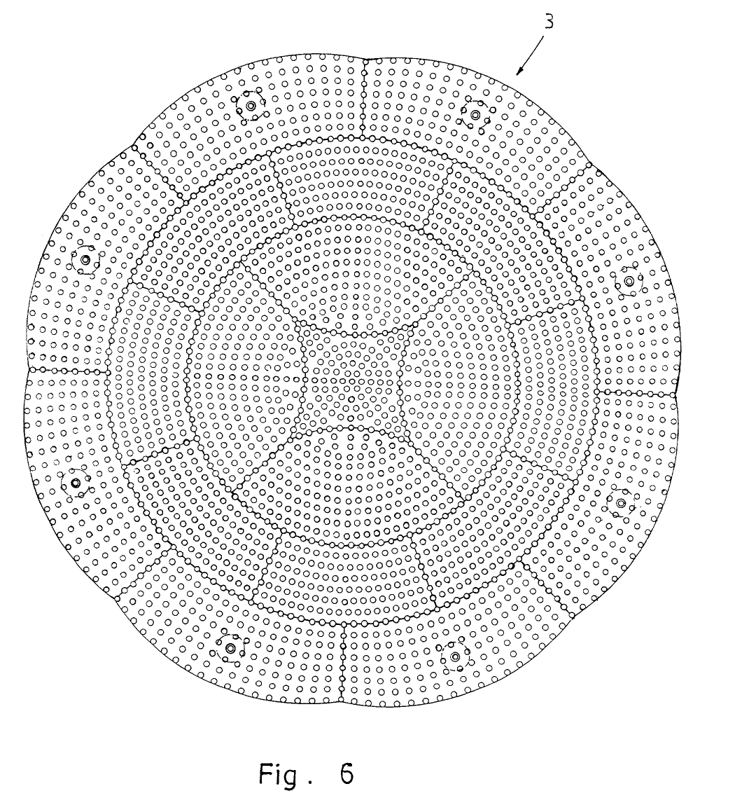

Referring to FIGS. 2 through 5 again, each unit pad 1 further comprises a plurality of mounting through holes 17 to which vacuum mounts 18 may be fastened for securing the combination massaging pad 2 to a flat floor surface.

FIG. 6 shows a combination massaging pad 3 according to an alternate form of the present invention. According to this embodiment, the combination massaging pad 3 is comprised of unit pads of different geometric shapes.

It is to be understood that the drawings are designed for purposes of illustration only, and are not intended for use as a definition of the limits and scope of the invention disclosed.

1. A combination massaging pad comprised of a plurality of unit pads connected to one another side by side, said unit pads each comprising a top sidewall, a bottom sidewall, a plurality of peripheral sides, a plurality of massaging studs at said top sidewall, a plurality of coupling notches disposed at said peripheral sides, a plurality of upright coupling rods and upright positioning rods disposed at said peripheral sides to serve with said coupling notches for enabling said unit pads to be fastened to one another by fastening respective coupling notches to respective upright coupling rods and upright positioning rods, and a plurality of coupling devices provided at said coupling notches which when two unit pads are attached together, secure the respective upright positioning rods of the unit pad attached thereto.

2. The combination massaging pad of claim 1 wherein the positioning rods of each of said unit pads each comprise a bottom plughole, and the coupling devices of each of said unit pads each comprise a connecting strip extended from a bottom edge of one of the peripheral notch of the respective unit pad and an upright plug rod extended from the respective connecting strip.

3. The combination massaging pad of claim 2 wherein the positioning rods of each of said unit pads each further comprise an expanded chamber in the respective bottom plughole, and the upright plug rod of each of said coupling devices has a top round head of size fitting the expanded chamber in the bottom plughole of each of said positioning rods.

4. The combination massaging pad of claim 1 wherein said unit pads each further comprise a patterned opening, a plurality of coupling notches and coupling devices disposed around said patterned opening, and a patterned patch fitted into said patterned opening, said patterned patch comprising a plurality of massaging studs at a top sidewall thereof, and a plurality of upright coupling rods and upright positioning rods disposed around the peripheral sides thereof and adapted for fastening to the coupling notches and coupling devices in said patterned opening.

5. The combination massaging pad of claim 1 wherein said unit pads each further comprise a plurality of bottom studs extended from the respective bottom sidewall.

6. The combination massaging pad of claim 1 wherein said unit pads each further comprise a plurality of mounting through holes for the mounting of vacuum mounts.
